(19) United States
(12) Patent Application Publication
(10) Pub. No.: US 2024/0335087 A1
(43) Pub. Date: Oct. 10, 2024

(54) DISHWASHER LATCH RESISTANT TO STICKING FROM FOOD SOILS

(71) Applicant: ILLINOIS TOOL WORKS INC., Glenview, IL (US)

(72) Inventors: Joel Charles BRAGG, Waterford, WI (US); Jeffrey John Krieger, Mukwonago, WI (US)

(73) Assignee: ILLINOIS TOOL WORKS INC., Glenview, IL (US)

(21) Appl. No.: 18/620,325

(22) Filed: Mar. 28, 2024

Related U.S. Application Data
(60) Provisional application No. 63/457,665, filed on Apr. 6, 2023.

(51) Int. Cl. A47L 15/42; E05C 3/12; H01H 21/22

(52) U.S. Cl. CPC A47L 15/4259; A47L 15/4274; E05C 3/12; H01H 21/22

(57) ABSTRACT

A dishwasher latch configured to be mounted to a dishwasher door and operable with a striker configured to be mounted to a dishwasher tub, the dishwasher latch includes a spring mechanism for drawing the door against the tub and sealing the tub in a latched position when the striker is fully engaged with the dishwasher latch. The dishwasher latch further includes a mouth engageable with the striker and a switch lever positioned at least partially across the mouth and in a path of the striker. A switch actuator is operatively connected to a switch for powering the dishwasher on or off wherein the switch actuator is coupled to the switch lever. A cam is connected between the switch lever and the spring mechanism wherein the cam is coupled to the switch lever when the switch lever is not in contact with the striker.

### CROSS REFERENCE TO RELATED APPLICATION

This application claims the benefit of U.S. Provisional Application, Ser. No. 63/457,665, filed on 6 Apr. 2023. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a dishwasher latch, in particular a dishwasher latch that prevents failure due to impingement of food soils.

### Description of Prior Art

Traditional dishwasher latches include a latch and a mating striker. The latches are generally mounted to the dishwasher door while the mating striker is mounted to the dishwasher tub. Latches typically include an over-center spring mechanism to pull the door tight with the tub against a gasket to prevent water leakage during the wash cycle.

The door latches are also typically equipped with a switch to signal when the door is open or closed. When the dishwasher door is open, it is normally horizontal and parallel to the ground. Many latches include a “mouth” feature or hole that receives the striker. When the door is open, the latch mouth feature may become a receptacle that can accumulate food and other soils spilled when a user loads dirty dishes into the dishwasher. Once accumulated within the latch mouth, such food soils may interfere with the proper operation of the dishwasher latch. Specifically, such food soils may stick closed the switch and thus permit the dishwasher to operate while the door is open, thereby creating a safety hazard.

Therefore, a latch design is desired that prevents such food soils accumulation while still maintaining the fundamental latch and striker design.

### SUMMARY OF THE INVENTION

As noted above, two important considerations for an effective dishwasher latch are its ability to seal the dishwasher tub during operation and to prevent operation of the dishwasher when the door is unlatched from the tub and in an open position. When in the open position, the door may be exposed to food soils and other matter that may drop onto and into the dishwasher door, such as into a mouth of the latch. It is desirable that the subject invention meets these performance considerations while preventing any decrease in performance created by food soils.

The subject invention includes features that mechanically couple a cam, which the striker engages, and a switch lever, which the striker presses, to a switch actuator. In this way, when the consumer pulls the door open, the switch actuator is forced to the off position-thereby signaling that the door is open. This prevents food soils from sticking to the door indicator switch in the closed position.

Traditional dishwasher latches do not include a mechanical coupling between the switch lever and the door switch actuator. If the switch actuator were to stick closed due to food soils, the dishwasher could run with the door open, which is a safety hazard and creates the risk of water damage to a user's home.

A critical function of the latch switch is to turn off the appliance when the door is open. The subject latch includes a coupling feature that couples the cam to the switch lever and a second coupling feature that connects the switch lever to the switch actuator. If the switch lever or switch actuator were to get stuck due to food soils, the force provided by the consumer to open the door would force the switch actuator into the door-open position, allowing the electrical contacts to open.

The first coupling, between cam and switch lever, is preferably a 1-way or interference coupling. This prevents the switch lever from moving if a user tampers with the latch, such as with a fork, knife, screwdriver, etc., by rotating the cam over center into the door-closed or on position. If the coupling between the cam and the switch lever were a 2-way coupling then in such an instance of tampering, the switch would turn on allowing the dishwasher to run with the door open.

Further, the subject latch preferably includes a self-healing feature. As such, the user simply needs to close the door to reset the mechanism back to the original door-open state.

Other objects and advantages will be apparent to those skilled in the art from the following detailed description taken in conjunction with the appended claims and drawings.

### BRIEF DESCRIPTION OF THE DRAWINGS

FIG. 1 shows a front perspective view of a latch according to one embodiment of the invention;

FIG. 2 shows the latch shown in FIG. 1 with a striker inserted in a mouth of the latch;

FIG. 3 shows a rear perspective view of the latch shown in FIG. 1;

FIG. 4 shows a rear perspective view of the latch shown in FIG. 2 with the striker inserted;

FIG. 5 shows a side cutaway view of the latch shown in FIG. 1; and

FIG. 6 shows a side cutaway view of the latch shown in FIG. 2 with the striker inserted.

### DESCRIPTION OF PREFERRED EMBODIMENTS

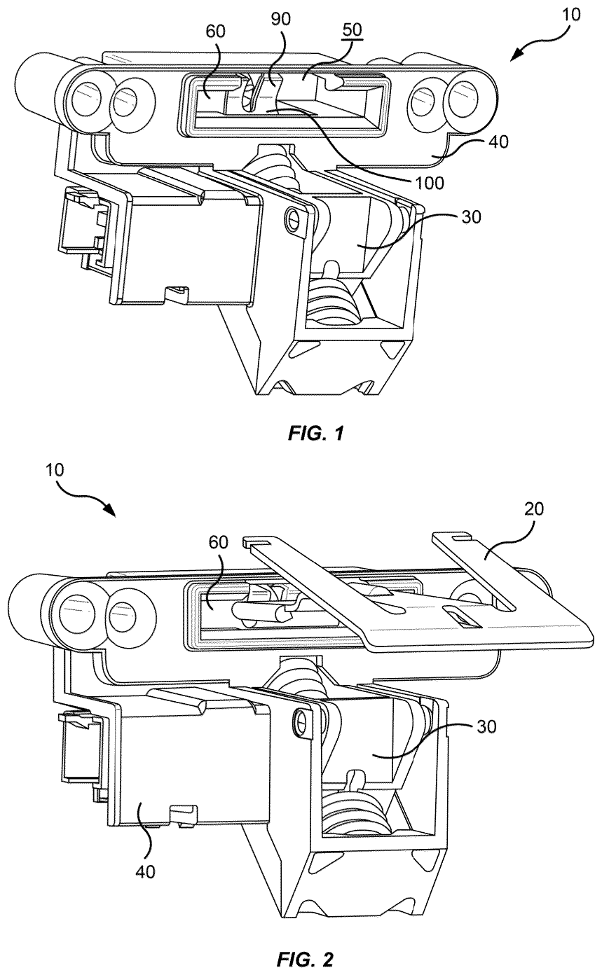

FIGS. 1-6 show various views of a dishwasher latch 10 configured to be mounted to a dishwasher door. The dishwasher latch 10 is preferably operable with a striker 20 configured to be mounted to a dishwasher tub. In alternative arrangements, the dishwasher latch 10 may be configured to be mounted to the dishwasher tub and the striker 20 may be configured to be mounted to the dishwasher door. In an alternative arrangement, the striker 20 may be integrated with the dishwasher door or dishwasher tub. The dishwasher latch 10 as described preferably includes an over-center spring mechanism 30 for drawing the door against the tub and sealing the tub in a latched position when the striker 20 is fully engaged with the dishwasher latch 10.

The latch 10 preferably includes a housing 40 forming the framework for the internal and external structure. The housing 40 is preferably molded or otherwise formed of a rigid, corrosion-resistant material such as plastic. A mouth 50 is formed in a front of the housing 40 and is sized and configured to be engageable with the striker 20.

A switch lever 60 is preferably positioned at least partially across the mouth 50 and in a path of the striker 20. The switch lever 60 includes a pivot end 63 pivotally attached to a portion of the housing 40 and a striker end 66 in the path of the striker 20.

A switch actuator 70 is operatively connected to a switch 80 for powering the dishwasher on or off. In some embodiments, the switch 80 may be directly in series with a dishwasher motor to power the dishwasher on or off. In alternative embodiments, the switch 80 may be configured as a low-voltage indicator switch that communicates with a dishwasher electronic control when it is acceptable or safe to power the dishwasher on or off. In such embodiments, the switch 80 is a low-voltage indicator used by the dishwasher electronic control to determine when it is appropriate or safe for the dishwasher to run.

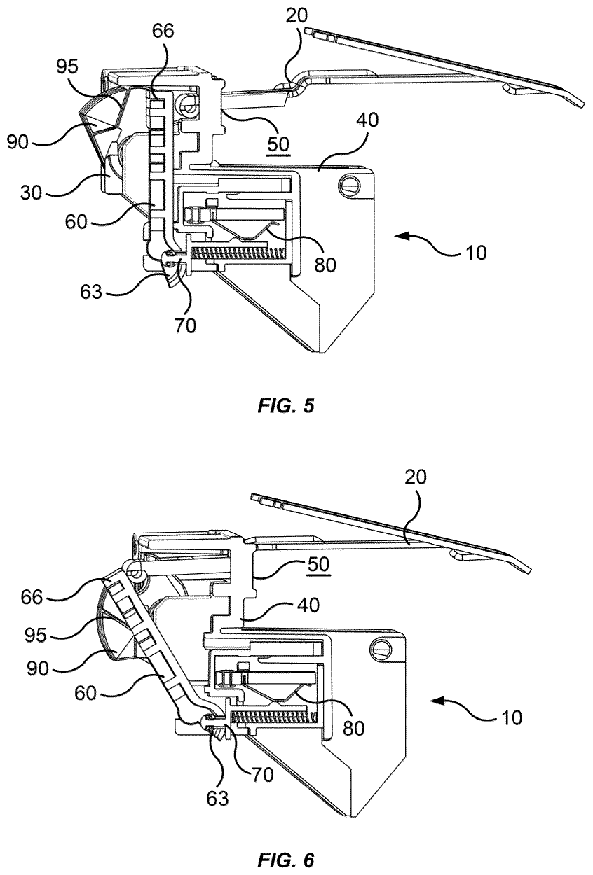

The switch actuator 70 is coupled to the switch lever 60, preferably at or near the pivot end 63. The switch actuator 70 preferably slides relative to the housing 40 to switch the dishwasher on or off and is biased to turn the switch 80 off, such as shown in FIGS. 5 and 6. As shown in FIG. 5, and as described in more detail below, the switch actuator 70 is configured to urge the switch 80 into an off position when the door is opened. As shown in FIG. 6, the switch actuator 70 is preferably pushed into engagement with the switch 80 when the striker 20 is fully inserted against the switch lever 60.

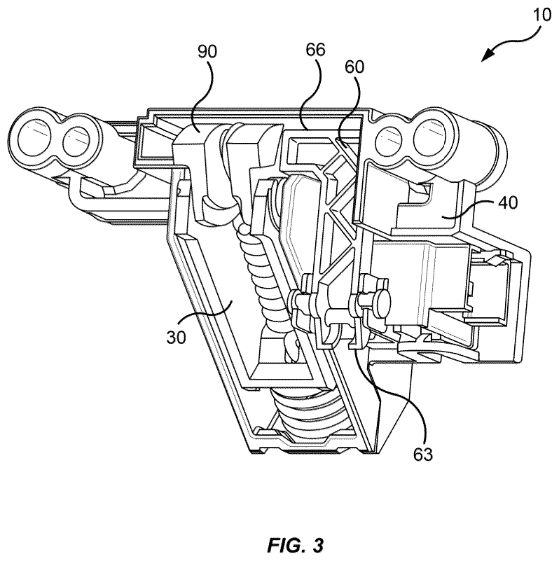

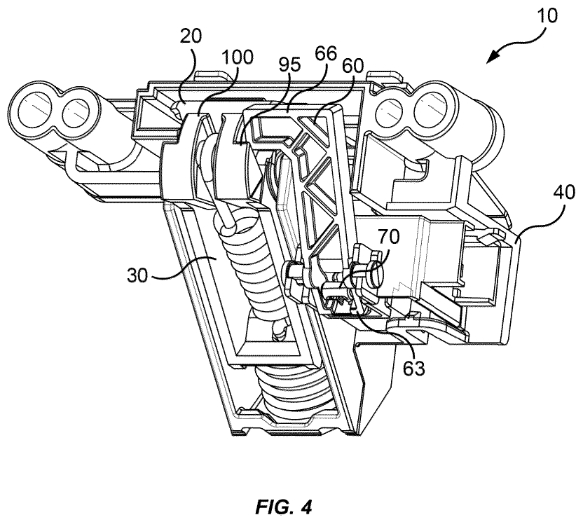

A cam 90 is preferably connected between the switch lever 60 and the spring mechanism 30. The cam 90 operates with the spring mechanism 30 to draw the door against the tub when the dishwasher is fully latched. The cam 90 is coupled to the switch lever 60 when the switch lever 60 is not in contact with the striker 20. As shown best in FIGS. 3 and 4, the cam 90 preferably includes an interference edge 95 and a contact edge 100. The interference edge 95 abuts a surface of the switch lever 90, thereby coupling with the switch lever 90 in an interference coupling, when the door is open or opening. In a preferred embodiment, the striker 30 is directly engaged with the switch lever 90 and the cam 90 at the same time while the door is closed or closing. The contact edge 100 of the cam 90 preferably abuts the striker 20 when the door is closed or closing. Further, the switch lever 60 is preferably configured to not move independently of the cam 90 as the dishwasher is latched.

As shown in the figures, the cam 90 is preferably pivotable such that at least a portion of the cam 90 is pivotable behind a portion of the striker 20 when the door is closed. Such an arrangement both inhibits the door from opening during a wash cycle but also forces the cam 90 to its home position when the door is opened which likewise pivots the switch lever 60 and thus moves the switch actuator 70. In this manner, even if there is food debris or other contamination in the latch 10, the action of pulling the door open relative to the tub will reset the switch to the off or unpowered position. This prevents the dishwasher from remaining in a powered condition when the door is open.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A dishwasher latch configured to be mounted to a dishwasher door and operable with a striker configured to be mounted to a dishwasher tub, the dishwasher latch having a spring mechanism for drawing the door against the tub and sealing the tub in a latched position when the striker is fully engaged with the dishwasher latch, the dishwasher latch comprising:
a housing;
a mouth in the housing, the mouth engageable with the striker; a switch lever positioned at least partially across the mouth and in a path of the striker,
a switch actuator operatively connected to a switch for powering the dishwasher on or off, the switch actuator coupled to the switch lever; and
a cam connected between the switch lever and the spring mechanism wherein the cam is coupled to the switch lever when the switch lever is not in contact with the striker.

2. The dishwasher latch of claim 1 wherein the cam includes an interference edge and a contact edge, the interference edge abutting a surface of the switch lever when the door is opened and the contact edge abutting the striker when the door is closed.

3. The dishwasher latch of claim 2 wherein at least a portion of the cam is pivotable behind a portion of the striker when the door is closed.

4. The dishwasher latch of claim 1 wherein the switch lever includes a pivot end and a striker end, wherein the switch actuator is coupled to the pivot end of the switch lever.

5. The dishwasher latch of claim 1 wherein the switch actuator slides relative to the housing to switch the dishwasher on or off and is biased to turn the switch off.

6. The dishwasher latch of claim 5 wherein the switch actuator is pushed into engagement with the switch when the striker is fully inserted against the switch lever.

7. The dishwasher latch of claim 5 wherein the switch actuator is configured to urge the switch into an off position when the door is opened.

8. The dishwasher latch of claim 1 wherein the striker is directly engageable with the switch lever and the cam at the same time.

9. The dishwasher latch of claim 1 wherein the switch lever is configured to not move independently of the cam as the dishwasher is latched.

10. The dishwasher latch of claim 1 wherein the switch actuator is operatively connected with respect to a low-voltage indicator of a dishwasher electronic control to determine when it is appropriate for the dishwasher to run.

11. The dishwasher latch of claim 1 wherein the striker is integrated with the dishwasher tub.

12. A dishwasher latch configured to be mounted to a dishwasher door and operable with a striker configured to be mounted to a dishwasher tub, the dishwasher latch having a spring mechanism for drawing the door against the tub and sealing the tub in a latched position when the striker is fully engaged with the dishwasher latch, the dishwasher latch comprising:
a housing having a mouth engageable with the striker;
a switch lever positioned at least partially across the mouth and in a path of the striker,
a switch actuator operatively connected to a switch for powering the dishwasher on or off, the switch actuator coupled to the switch lever; and
a cam connected between the switch lever and the spring mechanism wherein the cam is positioned to interfere with the switch lever when the striker is not in contact with the switch lever and wherein the cam is pivotable behind a portion of the striker when the striker is in a latched position.

13. A dishwasher latch configured to be mounted to one of a dishwasher tub and a dishwasher door and operable with a striker configured to be mounted to the other one of the dishwasher tub and the dishwasher door, the dishwasher latch having a spring mechanism for drawing the door against the tub and sealing the tub in a latched position when the striker is fully engaged with the dishwasher latch, the dishwasher latch comprising:
a housing;
a mouth in the housing, the mouth engageable with the striker;
a switch lever positioned at least partially across the mouth and in a path of the striker,
a switch actuator operatively connected to a switch for determining whether the dishwasher is safe to operate, the switch actuator coupled to the switch lever; and
a cam connected between the switch lever and the spring mechanism wherein the cam is coupled to the switch lever when the switch lever is not in contact with the striker.

14. The dishwasher latch of claim 13 wherein the cam includes an interference edge and a contact edge, the interference edge abutting a surface of the switch lever when the door is opened and the contact edge abutting the striker when the door is closed.

15. The dishwasher latch of claim 14 wherein at least a portion of the cam is pivotable behind a portion of the striker when the door is closed.

16. The dishwasher latch of claim 13 wherein the switch lever includes a pivot end and a striker end, wherein the switch actuator is coupled to the pivot end of the switch lever.

17. The dishwasher latch of claim 13 wherein the switch actuator slides relative to the housing to switch the dishwasher on or off and is biased to turn the switch off.

18. The dishwasher latch of claim 17 wherein the switch actuator is pushed into engagement with the switch when the striker is fully inserted against the switch lever.

19. The dishwasher latch of claim 17 wherein the switch actuator is configured to urge the switch into an off position when the door is opened.

20. The dishwasher latch of claim 13 wherein the striker is directly engageable with the switch lever and the cam at the same time.
